(19) United States
(12) Patent Application Publication
(10) Pub. No.: US 2012/0102568 A1
(43) Pub. Date: Apr. 26, 2012

(54) SYSTEM AND METHOD FOR MALWARE ALERTING BASED ON ANALYSIS OF HISTORICAL NETWORK AND PROCESS ACTIVITY

(75) Inventors: Lee Codel Lawson Tarbotton, Buckinghamshire (GB); Robert J. Ackroyd, Buckinghamshire (GB); Alex J. Hinchliffe, Buckinghamshire (GB)

(73) Assignee: MCAFEE, INC., Santa Clara, CA (US)

(21) Appl. No.: 12/911,927

(22) Filed: Oct. 26, 2010

(51) Int. Cl. G06F 21/00

(52) U.S. Cl. 726/23

(57) ABSTRACT

A method for malware protection includes receiving detection information for detecting malware on an electronic device, accessing historical information of an electronic device, comparing the detection information to the historical information, and based on the comparison of the detection information with the historical information, alerting a user of the electronic device of risks of malware evidenced by the historical information. Comparing detection information to historical information includes determining that information from a first category of historical information is associated with a source of malware, cross-referencing information from a second category of historical information to the information from the first category, and associating the information from the second category with the malware.

### TECHNICAL FIELD OF THE INVENTION

The present invention relates generally to computer security and malware protection and, more particularly, to a system and method for malware alerting based on forensic analysis of historical network and process activity.

### BACKGROUND

Anti-malware applications must periodically update signatures or other indicia of malware that the applications must use to detect malware, to defeat ever-changing and newly created malware. When anti-malware applications update signatures and scan computers and other electronic devices for malware, such analysis is conducted considering the present state of the computer or other electronic device.

Malware may include, but is not limited to, spyware, rootkits, password stealers, spam, sources of phishing attacks, sources of denial-of-service-attacks, viruses, loggers, Trojans, adware, or any other digital content that produces unwanted activity.

### SUMMARY

A method for malware protection includes receiving detection information for detecting malware on an electronic device, accessing historical information of an electronic device, comparing the detection information to the historical information, and based on the comparison of the detection information with the historical information, alerting a user of the electronic device of risks of malware evidenced by the historical information. Comparing detection information to historical information includes determining that information from a first category of historical information is associated with a source of malware, cross-referencing information from a second category of historical information to the information from the first category, and associating the information from the second category with the malware.

In another embodiment, an article of manufacture includes a computer readable medium and computer-executable instructions carried on the computer readable medium. The instructions are readable by a processor. The instructions, when read and executed, cause the processor to receive detection information for detecting malware on an electronic device, access historical information of an electronic device, compare detection information to the historical information, and, based on the comparison of the detection information with the historical information, alert a user of the electronic device of risks of malware evidenced by the historical information. Causing the processor to compare detection information to the historical information includes causing the processor to determine that information from a first category of historical information is associated with a source of malware, cross-reference information from a second category of historical information to the information from the first category, and associate the information from the second category with the malware.

### BRIEF DESCRIPTION OF THE DRAWINGS

For a more complete understanding of the present invention and its features and advantages, reference is now made to the following description, taken in conjunction with the accompanying drawings, in which:

FIG. 1 is an illustration of an example system for detecting malware and alerting based on forensic analysis of historical network and process activity;

FIG. 2 is an example embodiment of historical information that may be tracked in metadata in an electronic device;

FIG. 3 shows an example embodiment of a method for utilizing historical information to detect the effects of malware, and alert a user; and

FIG. 4 shows another example embodiment of a method for utilizing historical information to detect the effects of malware, and alert a user.

### DETAILED DESCRIPTION

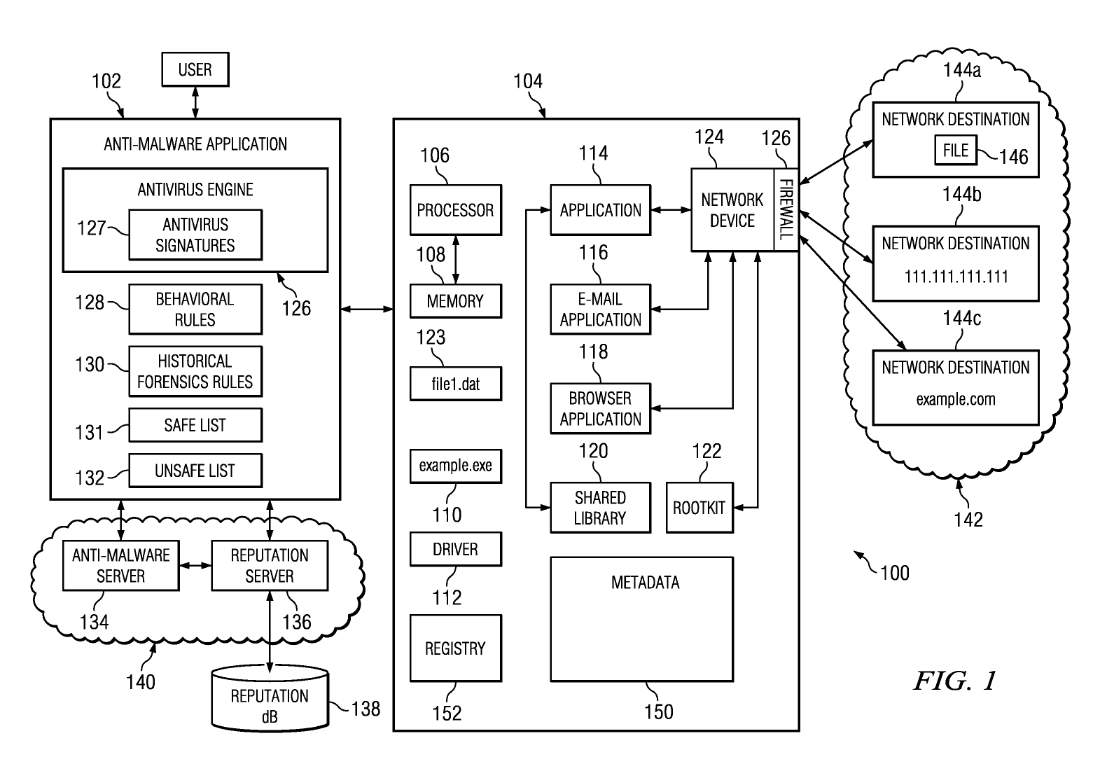

FIG. 1 is an illustration of an example system 100 for detecting malware and alerting based on forensic analysis of historical network and process activity. System 100 may comprise a anti-malware application 102, an electronic device 104, and servers such as an anti-malware server 134 and a reputation server 136. Anti-malware application 102 may be configured to scan electronic device 104 for malware. Anti-malware application 102 may be configured to analyze information regarding historical network and process activity of elements of electronic device 104 to determine the activity of malware and take subsequent remedial action. Anti-malware application 102 may be configured to alert a user of electronic device 104 of malware infections, effects, and corrective actions to be taken.

Anti-malware application 102 may be configured to communicate with anti-malware server 134 and reputation server 136 over network 140 to determine methods, techniques, rules, or similar mechanisms by which monitor 104 may be scanned for malware, and by which historical network and process activity of elements of electronic device 104 may be evaluated for indicia of malware.

In one embodiment, anti-malware application 102 may reside on electronic device 104. Anti-malware application 102 may be loaded and executed on electronic device 104. In such an embodiment, anti-malware application 102 may be configured to operate on electronic device 104.

In another embodiment, anti-malware application 102 may be configured to operate in a cloud computing scheme. Anti-malware application 102 may comprise software that resides on a network such as network 140, and may be loaded and executed on a machine in network 140. Anti-malware application 102 may be communicatively coupled to electronic device 104 through network 140 or any other suitable network or communication scheme. Anti-malware application 102 may be configured to scan electronic device 104 without executing on electronic device 104. Anti-malware application 102 may be communicatively coupled to anti-malware server 134 and reputation server 136 through network 140. Reputation server 136 and anti-malware server 134 may comprise servers on network 140. In one embodiment, one or more of anti-malware application 102, reputation server 136 and anti-malware server 134 may reside on the same network. In one embodiment, one or more of anti-malware application 102, reputation server 136 and anti-malware server 134 may reside on the same hardware.

Anti-malware application 102 may be implemented in an application, process, shared library, executable, module, script, function, or any other suitable technique for carrying out the functions described in the present disclosure. Anti-malware application 102 may comprise one or more elements for detecting indicia of malware on electronic device 104. Anti-malware application 102 may comprise an antivirus engine 126. Antivirus engine 126 may be configured for anti-malware application to analyze the contents of memory, files, or other components of electronic device 104 to determine whether the component matches an anti-virus signature 127 that indicates a particular infection of malware. Anti-malware application 102 may comprise behavioral rules 128. Behavioral rules 128 may be configured to match the actions of processes of electronic device 104, wherein the processes indicate an infection of malware. Anti-malware application 132 may comprise an unsafe list 132. Unsafe list 132 may contain the identities of files, processes, drivers, network destinations, or other components of or associated with an electronic device that may be known associated with malware. Anti-malware application 132 may comprise a safe list 131. Safe list 131 may contain the identifies of files, processes, drivers, network destinations, or other components of or associated with an electronic device that may be known to be free of any association with malware. Anti-malware application 102 may comprise behavioral rules 128, by which the operation of processes, scripts, executables, modules, or other elements of an electronic device may be monitored to determine whether the element is acting in a manner that indicates an association with malware.

Electronic device 104 may comprise any device configurable to interpret and/or execute program instructions and/or process data, including but not limited to: a computer, desktop, server, laptop, personal data assistant, or smartphone. Electronic device 104 may comprise a processor 106 coupled to a memory 108. Anti-malware application 102 may reside on electronic device 104, or on any other electronic device, server, or other suitable mechanism to scan electronic device 104 for suspicious device drivers. Anti-malware application 102 may comprise any application, process, script, module, executable, server, executable object, library, or other suitable digital entity. Anti-malware application 102 may be communicatively coupled to reputation server 136 over network 112. Anti-malware application 102 may be configured to reside in memory 108 for execution by processor 106 with instructions contained in memory 108.

Processor 106 may comprise, for example a microprocessor, microcontroller, digital signal processor (DSP), application specific integrated circuit (ASIC), or any other digital or analog circuitry configured to interpret and/or execute program instructions and/or process data. In some embodiments, processor 106 may interpret and/or execute program instructions and/or process data stored in memory 108. Memory 108 may be configured in part or whole as application memory, system memory, or both. Memory 108 may include any system, device, or apparatus configured to hold and/or house one or more memory modules. Each memory module may include any system, device or apparatus configured to retain program instructions and/or data for a period of time (e.g., computer-readable media).

Electronic device 104 may comprise one or more applications, processes, scripts, modules, or other elements operating on electronic device 104. For example, electronic device 104 may contain application 114, email application 116, shared library 120, browser application 118, driver 112, or example.exe 110. Such elements may comprise an application, process, shared library, executable, module, script, and/or function, loaded partially or wholly within memory 108 for execution by processor 106. Electronic device 104 may comprise files, databases, operating system components, or other digital entities residing within memory 108. For example, electronic device 104 may contain the elements described as operating on electronic device 104, as well as rootkit 122, file1.dat 123, or registry 152. Rootkit 122 may be stand-alone malware, or malware embedded in another entity of electronic device 104. File1.dat 123 may comprise data for use by other applications of electronic device 104. Registry 152 may be a repository, for example, for operating system or application settings, preferences, configurations, or registers. Registry 152 may be implemented in a file, database, or other suitable entity. Electronic device 104 may contain a network device 124, by which communication to one or more network destinations 144 may be made. Electronic device 104 may contain a firewall 126 operating on network device 124. One or more elements of electronic device 104 may be communicatively coupled to network device 124, including application 114, email application 116, browser application 118, or rootkit 122.

Historical information about the operation and contents of electronic device 104 may be tracked and stored. Such information may be stored in metadata 150. In one embodiment, electronic device 104 may be configured to store historical information in metadata 150. In another embodiment, antivirus application 102 may be configured to store historical information in metadata 150. In yet another embodiment, a combination of antivirus application 102, electronic device 104 may be configured to store historical information in metadata 150. Such historical information may include information on, for example, network traffic of electronic device 104, or the execution history of code within electronic device 104.

Metadata 150 may be stored on electronic device 104. In one embodiment, metadata 150 may be stored on a separate device, such as a device in which anti-malware application 102 is operating. Metadata 150 may be implemented in a data structure, record, database, file, or any other suitable manner. Portions of metadata 150 may be found by accessing different parts of electronic device 104 where the generation of underlying data occurs natively, in metadata associated with the different parts of electronic device 104. In one embodiment, metadata 150 may be implemented in more than one data structure, record, database, or file. In such an embodiment, metadata 150 may be stored in the different parts of electronic device 104 which gave rise to the historical information. In another embodiment, metadata 150 may contain the historical information aggregated into organized locations.

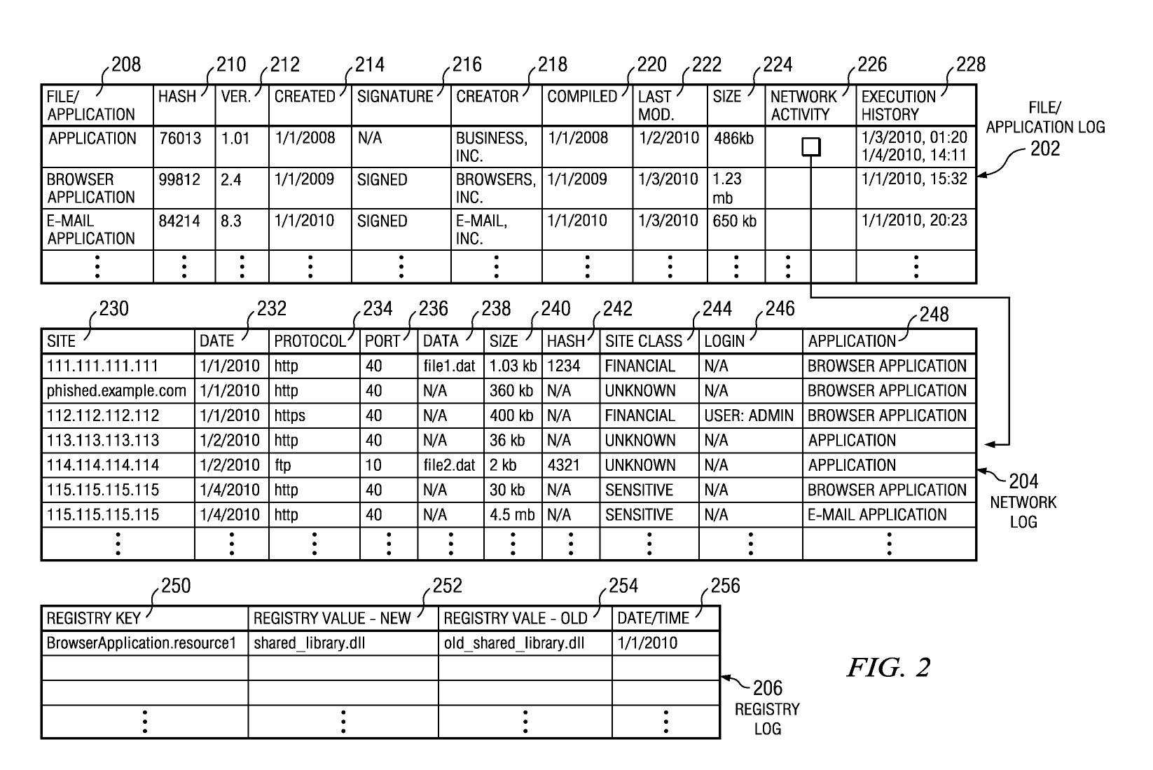

FIG. 2 is an example embodiment of historical information 200 that may be tracked in metadata 150 in an electronic device 104. In embodiments where portions of metadata 150 may be found by accessing different parts of electronic device 104 where the generation of underlying data occurs natively, FIG. 2 may represent a logical association of such different parts. In embodiments where such underlying data may be aggregated, FIG. 2 may demonstrate the results of such aggregation. In such embodiments, metadata 150 may be implemented by the embodiment shown in FIG. 2.

Historical information 200 may be implemented in one or more records, data structures, databases, files, or other suitable digital entities. Historical information 200 may contain one or more logs that organize information regarding the historical operation and makeup of an electronic device. For example, historical information may contain file/application log 202, network log 204, or registry log 206. In one embodiment, such logs represent the logical association of metadata of electronic device 104, wherein the metadata may be found in the parts of electronic device 104 which gave rise to the generated metadata.

File/application log 202 may contain information regarding files, applications, and other entities of electronic device 104. File/application log 202 may contain fields representing various aspects of the operation or existence of the entity. For example, file/application log 202 may contain a field corresponding to a hash value 210 or other identifying signature of the represented file or application. File/application log 202 may contain a digital signature 216 validating the file or application, as well as the identity of the signing entity. File/application log 202 may contain fields representing the version 212 of the file or application, its creator 218, size 224, last modified date 222, and compiled date 220. Version 212 may indicate patches applied to the application. The application itself, or the version 212, may indicate a vulnerability status of the application with regards to risks of infection by malware. Such a status may be deduced using a digital forensic rule. File/application log 202 may contain a field of a record of execution history 228, or a record of any other elements of electronic device 104 that have been accessed by the file or application. File/application log 202 may contain a record of network activity 226 by the file or application. In one embodiment, the record of network activity 226 in file/application log 202 may be implemented by linking to or accessing the contents of network log 204.

Network log 204 may contain information regarding network traffic to or from electronic device 104, as well as the components of electronic device 104 associated with the network traffic. Network log 204 may be implemented wholly or in part with information from a log of firewall 126. Network log 204 may contain information regarding various aspects of network communication of electronic device 104. For example, network log 204 may contain fields for an address 230 or other identification of a network destination which has communicated with electronic device 104, as well as the date 232, time, protocol 234, and port 236 used in the communication. Network log 204 may contain fields containing or referencing the data 238 transferred between electronic device 104 and the network destination. Data 238 may include, for example, the actual data, a pointer to the actual data, or the number of packets sent or received. Network log 204 may also contain the size 240 of the data sent or received. Network log 204 may contain a hash 242 of the data sent or received, which may include a signature, checksum, or other suitable identification of the data. Network log 204 may contain a site classification 244 of the network destination. Site classification 244 may include a description of the kind of network destination, for example: “financial;” “sensitive;” or “e-mail.” Site classification 244 may contain more than one designation for the network destination. Network log 204 may contain login information 246 associated with the network destination. Login information 246 may include a username. Network log 204 may contain an identification of the application 248 on electronic device 104 associated with the network activity. The identification of the application 248 may identify a file, script, executable, module, shared library, executable, or other entity of electronic device 104 associated with the network activity. The field for network activity 226 of file/application log 202 may be populated by using the identification of the application 248 of the network log 204 as an index.

Registry log 206 may contain information associated with a repository of system and application information, such as registry 152. The information and fields of registry log 206 may vary according to the nature of electronic device 104, its applications, and operating system. Registry log 206 may contain information showing changes to registry 152. Registry log 206 may contain a registry key 250, which may identify an application and a resource of the application. Registry log 206 may contain fields for a new registry value 252 and the old registry value 254, reflecting the new and previous values associated with registry key 250. Registry log 206 may contain a date 256, reflecting the date and time a change to the registry was made. New registry value 252 and old registry value 254, or another field of registry log 206, may be configured to indicate whether a registry key 250 was deleted or created.

Returning to FIG. 1, information making up metadata 150 may be created natively, as a consequence of the normal operation of electronic device 104. For example, files such as file1.dat 123 may contain native metadata indicating the last time the file was modified, corresponding to the last modified field 222 of file/application log 202. In such an example, such metadata may be accessed directly by anti-malware application 102.

In one embodiment, metadata 150 may be configured to be populated by monitoring the operation of electronic device 104 for the creation of such new information. In such an embodiment, such information may be logged to metadata 150 by anti-malware application 102, electronic device 104, or another suitable entity monitoring electronic device 104. For example, a change may be made in file1.dat 123 which would result in a change of last modified field 222; the change may be observed by anti-malware application 102, and the change recorded in file/application log 202. In another example, the networking operations of electronic device 104 may be recorded in part by firewall 126. In one embodiment, the information shown in network log 206 may accessed by anti-malware application 102 accessing logs of firewall 126. In another embodiment, anti-malware application 102, or another suitable application, may create network log 206 based on the information contained within the logs of firewall 206.

In another embodiment, metadata 150 may be configured to be populated by monitoring the operation of electronic device 104, and subsequently adding content to metadata 150 based upon the observed operation. For example, if the last modified date 222 of an application were to change, anti-malware application 102, or another suitable application, may be configured to determine the hash 210 of the newly modified application. If the hash 210 were different than a previous value, the change may be noted. In another example, as information is gathered in network log 204, anti-malware application 102, or another suitable application, may be configured to classify the network destination in site classification 244 by matching the site 230 to information from reputation server 136.

Anti-malware application 102 may comprise historical forensics rules 130. Historical forensics rules may comprise logical associations between historical information of an electronic device, such as metadata 150, and identified instances of malware. Upon detection of malware, anti-malware application 102 may be configured to access historical forensics rules to determine information, such as metadata 150, associated with malware. Anti-malware application 102 may be configured to use such information to alert a user or administrator of electronic device of problems arising from the infection of malware.

For example, historical forensics rules 130 may include an association of an infection of malware with a network destination 144a which is known to distribute the malware. If anti-malware application 102 detects malware, anti-malware application 102 may be configured to use the information in historical forensics rules 130 to determine if and when the network destination 144a was visited from network log 204, establishing a possible time at which the electronic device 104 was detected. Anti-malware application 104 may be configured to provide a user of anti-malware application 104 of the possible date of the infection. If the malware was detected in a particular component of electronic device 104, such as application 114, anti-malware application 102 may be configured to determine what network traffic may be related to the application 114 by file/application log 202 and network log 204. Anti-malware application 102 may be configured to determine whether any data 238 was transferred by the infected application 114 to other network destinations 144. Anti-malware application 104 may be configured to alert a user with regards to the network traffic generated by the infected application 114. If one of such network destinations 144 accessed by the infected application 114 is associated with malware by unsafe list 132, anti-malware application 104 may be configured to alert the user. In one embodiment, anti-malware application 102 may be configured to alert the user if one of the network destinations 144 accessed by the infected application 102 consists of a sensitive website, such as one with a site class 244 categorization of “FINANCIAL.” For example, the infected application 114 may have accessed a banking website, in which case anti-malware application 102 may be configured to notify a user that the malware may have phished or otherwise compromised a bank account. In such an example, anti-malware application 102 may identify the network destination 144 to the user, with an alert that banking accounts may have been accessed by the infected application 114.

Anti-malware application 102 may be configured to receive updates from anti-malware server or reputation server 136 regarding the information contained within its malware detection components such as antivirus signatures 127, behavioral rules 128, safe list 131 or unsafe list 132.

Anti-malware application 102 may be configured to determine that electronic device 104 is infected with malware through the application of any suitable technique, method, rule, or module. In various embodiments, anti-malware application 102 may be configured to utilize anti-virus engine 126, using antivirus signatures 127, to detect the presence of malware on electronic device 104. Anti-malware application 102 may be configured to utilize behavioral rules 128 to detect the presence of malware on electronic device 104. Anti-malware application 102 may be configured to identify suspicious components of electronic device 104, and verify the identity, nature, or malware status by verification with reputation server 136.

In one embodiment, anti-malware application 102 may be configured to determine that electronic device 104 is infected with malware through the use of historical information, such as metadata 150. For example, anti-malware application 102 may be configured to monitor the action of network device 124 for use by various components of electronic device 104. In such an example, anti-malware application 102 may be configured to examine the inbound or outbound traffic of network device 124 to determine whether network destinations 144 associated with the network traffic are listed in unsafe list 132. If such network destinations 144 are listed in unsafe list 132, anti-malware application 102 may be configured to take appropriate corrective or preventative action. Such action may include, for example, blocking access, alerting a user, logging the associated information, or employing additional anti-malware behavior monitoring techniques. After receiving a new version of unsafe list 132, anti-malware application 102 may be configured to determine network destinations that have been newly added to unsafe list 132. Anti-malware application 102 may be configured to determine whether historical data, such as metadata 150, indicates that electronic device 104 may have been exposed to malware by accessing unsafe network destinations. For example, anti-malware application 102 may be configured to determine from examination of network log 204 whether any such newly added network destinations in unsafe list 132 have previously communicated with network device 124. If examination of network log 204 indicates that an unsafe network destination 144 previously communicated with electronic device 104, anti-malware application 102 may alert a user of electronic device 104 that unsafe network destinations were visited before the possible threat was identified. Anti-malware application 102 may be configured to identify the kinds of risks, such as phishing, that may have been encountered during communication with the network destination 144. For example, anti-malware application 102 may be configured to alert a user that a website used to spoof a financial services website was previously visited, and that any accounts with the financial services website may be been phished.

Anti-malware application 102 may be configured to alert a user of electronic device 104 of any connection between historical information, such as metadata 150, and a threat of malware. Anti-malware application 102 may be configured to use any suitable process or mechanism to alert a user of electronic device. For example, anti-malware application 102 may be configured to display a pop-up message, send an e-mail, or record information in a security log. The alerts provided by anti-malware application 102 may provide information about a malware threat, such as identifications of compromised websites, accounts, applications, files, or network traffic. The alerts may be tailored by evidence of particular kinds of network traffic. For example, if network traffic indicated in network log 204 shows that a compromised financial website was visited, identified through site class 244, detailed information regarding login 246 accounts and detailed warnings regarding phished accounts may be provided in the alert. The alerts may be tailored by evidence of the particular kinds of malware threat that was identified. For example, if network traffic indicated in network log 204 shows that an application 248 infected with a Trojan participated in a denial-of-service attack on a network destination 144—in which an unsuspecting computer may be used as a “zombie”—the alert may contain instructions on how to modify a firewall setting to prevent such behavior in the future. In one embodiment, alerts may be coded to uniquely identify threats and effects of malware. In such embodiment, alerts may take the form of scripts, files, or other mechanisms of indicating information to digital entities.

The user receiving alerts from anti-malware application may be any suitable person or entity able to take corrective action against the detected threats or effects of malware. In one embodiment, the user may be an actual operator of electronic device 104. In another embodiment, the user may be an administrator of electronic device 104. In yet another embodiment, the user may include a combination of hardware and software; for example, a server, middleware, or module.

Networks 140 and 142 may comprise any suitable networks for communication between electronic device 104, anti-malware application 102, anti-malware server 134, reputation server 136, and network destinations 144. Such networks may include but are not limited to: the Internet, an intranet, wide-area-networks, local-area-networks, back-haul-networks, peer-to-peer-networks, or any combination thereof.

Network destinations 144 may include servers, websites, electronic devices, network equipment, or any other entity with which electronic device 104 may communicate. Network destinations 144 may include a file 146, which may be downloaded or uploaded by electronic device 104. Network destinations 144 may be identified by an address, such as the internet protocol (“IP”) address 111.111.111.111, or a domain name, such as “example.com.”

In operation, historical information, such as metadata 150, may be generated from the operation of electronic device 104. Anti-malware application 102 may be updated, by anti-malware server 134 or reputation server 136, with new information for detecting malware, such as new information for components such as anti-virus signatures 127, behavioral rules 128, or unsafe list 132. Anti-malware application 102 may analyze the historical data using the updated detection information to alert users of electronic device 104 regarding malware infections, their effects, and possible remedial actions. Anti-malware application 102 may utilize historical forensic rules 130 associating historical information with malware to conduct its analysis. In one embodiment, anti-malware application 102 may scan electronic device 104 for malware utilizing the updated detection information, and analyze the results of such a scan with the historical information to alert users. In another embodiment, anti-malware application 102 may alert users by analyzing historical information by applying the new detection information to the historical information. In yet another embodiment, anti-malware application 102 may be configured to analyze the historical information, and based upon the detection information alone.

Anti-malware application 102 may scan electronic device 104 to determine whether malware is currently on electronic device, or in active communication with electronic device 104. Anti-malware application 102 may apply anti-virus signatures to detect the installation of malware on electronic device 104. Such malware may be resident, for example, in application 104. Anti-malware application 102 may apply behavioral rules 128 to detect the installation of malware on electronic device 104. For example, anti-malware application 102 may detect the attempted change of protected memory space in an operating system of electronic device 104 by driver 112. Anti-malware application 102 may determine whether applications or web traffic are associated with malware as given in unsafe list 132. For example, if the address of network destination 144b is on unsafe list 132, access to network device 124 may be blocked and the requesting application scanned for malware.

However, scanning electronic device 104 might not provide a complete analysis of the malware risks present. For example, a phishing attack based from a network destination 144 might pre-date the appearance of the network destination 144 on unsafe list 132. In another example, a malware infection of an application 114 may have been undetected until anti-malware application 102 was updated with an anti-virus signature 127 corresponding to the specific instance of malware, and its effects before detection may be unknown. In another example, a browser application 118 may have had a security hole, but was later patched. In another example, a rootkit 122 may have infected electronic device 104, but is undetectable except in a safe mode of the operating system of electronic device 104. Anti-malware application 102 may detect malware, or the effects of malware and alert a user in these and other examples, by conducting forensic analysis of historical information.

In another example, anti-malware application 102 may determine that a shared library 120 has been infected with malware, that the shared library 120t has made changes, and that the malware is known to change registry 152 to allow exploitation in another application, such as browser application. Anti-malware application may use information that the malware is known to change information in registry 152 to alert the user of the possible changes. For example, shared library 120 may have changed registry settings for a particular registry key 250 for browser application 118, from pointing to one shared library to another. Anti-malware application 102 may alert a user that such a change was made, and that the change may have been conducted by malware. The user may be presented the option of undoing the changes.

In one embodiment, anti-malware application 102 may scan electronic device 104 for malware utilizing the updated detection information, and analyze the results of such a scan with the historical information to alert users. For example, electronic device 104 may access a website hosted on network destination 144c, example.com. Example.com may be a normally safe website to visit, but perhaps was temporarily compromised and hijacked to distribute malware. At the time of the access, network destination 144c, with address 111.111.111.111, may not have been listed in unsafe list 132. At the time of the access, antivirus signatures 127 corresponding to the malware may not have been available to anti-malware application 102. At a time after electronic device 104 has accessed network destination 144c antivirus signatures 127 may be updated, and the presence of the malware on electronic device 104 may be detected and removed by anti-malware application 102.

Anti-malware application 102 may examine historical information, such as metadata 150, of electronic device 104 to determine any additional effects of the identified malware, and subsequently alert a user of anti-malware application 102 or of electronic device 104. For example, anti-malware application 102 may examine network log 204 to determine the date 232 when address 111.111.111.111 was accessed, yielding a possible date of infection, Jan. 1, 2010.

Anti-malware application 102 may alert a user that the possible date of infection of the particular malware was Jan. 1, 2010. If the malware had infected a particular file or application, anti-malware application 102 may determine how often that file or application had been accessed or executed from file/application log 202, by, for example, examining execution history 228. For example, anti-malware application 102 may determine that application 114 was operated twice subsequent to infection, one Jan. 3, 2010 and on Jan. 4, 2010. Such information may inform a user of appropriate corrective action. For example, if application 114 had access to sensitive information, and was executed, steps may be taken to secure the sensitive information, or to take proactive steps to correct for its compromise. Likewise, an alert that an infected application 114 was not accessed or executed may inform a user that corrective steps are not required.

Anti-malware application 102 may determine whether the identified malware had generated any network traffic by examination of information from network log 204. In one embodiment, anti-malware application 102 may make such determinations by examining information from network log 204 from after the determined possible date of infection. For example, if application 114 was identified as the entity infected with malware, anti-malware application 102 may determine from network log 204 that application 114 subsequently accessed a network destination with the website 113.113.113.113 on Jan. 2, 2010. Anti-malware application 102 may alert a user that the infected application 114 accessed the network destination, along with details of information transferred. Anti-malware application 102 may advise the user that if the network destination is unknown to the user, or if the network destination has been identified on unsafe list 132, that the access to the network location may have been malicious. In such a case, appropriate corrective action may then be taken, such as blocking access to the network location by firewall 126 or other network security module. The contents of the information transferred, such as data 238, may be presented to the user to determine the scope of any loss of information.

In another embodiment, anti-malware application 102 may detect malware or indicia of malware on electronic device 104 and alert users, by analyzing the historical information based upon detection information. Anti-malware application 102 may, periodically or in real-time, examine metadata 150 for indications of malware. For example, electronic device 104 may be infected by a rootkit 122. Such a rootkit might be detectable only when the operating system of electronic device 104 is operating in a “safe mode.” However, electronic device 104 might be operating in a normal mode, meaning the infection may go undetected for some time. Anti-malware application 102 may examine network log 204 to determine whether or not electronic device 104 is accessing malicious network destinations 144. Anti-malware application 102 may determine that 114.114.114.114, an address for a network destination 144 with a known association with malware, has been accessed by electronic device 104. Such malware might take the form of rootkits, and the network destination 144 might be a known hosting site for information stolen by rootkits. Anti-malware application 102 may thus determine that electronic device 104 may be infected by malware such as rootkit 122, which is posting data on network destination 144. In such a case, anti-malware application 102 may block access to the network destination 144 using firewall 124 or another suitable device or module. Anti-malware application 102 may alert a user that rootkit 122 may be resident on electronic device 104, that it has transferred information such as data 238, or is making use of an application 248. Anti-malware application 102 may alert a user of suitable means of detecting rootkit 122 and cleaning it from electronic device 104, such as rebooting into a safe mode of the operating system of electronic device 104, and running anti-malware application 102 to scan for rootkit 122. In one embodiment, such steps may be automated.

In yet another embodiment, anti-malware application 102 may detect malware or indicia of malware on electronic device 104 and alert users, by analyzing historical information by applying the new detection information to the historical information. For example, a user of electronic device 104 might fall victim to a phishing attack and unwittingly access a phished network destination 144, “phished.example.com,” handing over log-in information. The network destination 144 used in the phishing scheme might not have been identified in unsafe list 132 at the time of the attack. Subsequently, the network destination 144 might be identified as a malicious network destination in detection information, such as unsafe list 132, due to its identified relationship with malware. Anti-malware application 102, upon receipt of new detection information such as unsafe list 132, may examine network log 204 to determine whether the electronic device 104 had previously accessed unsafe network destinations. In this example, anti-malware application 102 may determine from network log 204 that browser application 118 had accessed phished.example.com on Jan. 1, 2010. Anti-malware application 102 may alert the user that access to the malicious site had occurred on the particular date, and that remedial action may need to be taken.

Anti-malware application 102 may tailor the information in the alert to the user based upon the type of malware associated with the malicious network destination 144, as well as the information contained within network log 204. Anti-malware application 102 may tailor suggested corrective action in the alert. For example, if the network destination 144 has been identified as the source of a phishing attack, the user may be alerted that the malicious network destination 144 was accessed, and information such as log-in information associated with the legitimate network destination may have been compromised. Identification of the legitimate network destination that was spoofed may prompt a user to pinpoint specifically what account information has been compromised, so that the information may be changed. The data 238 transferred to the malicious network destination 144 may be displayed in the alert, indicating to the user specifically what information had been compromised. Whether the legitimate network destination was used for sensitive information or operations may be included in the alert to the user.

In another example, browser application 118 or e-mail application 116 might access a network destination 144 that has been temporarily compromised to distribute malware through a security hole exploitation in browser and e-mail applications. After it is determined that the network destination 144 has been compromised, and anti-malware application 102 updated with corresponding detection information, anti-malware application 102 may determine whether such programs accessed the network destination 144 while it was vulnerable. Anti-malware application 102 may determine whether such programs were vulnerable to the security hole when the program accessed the network destination 144. For example, anti-malware application may receive information indicating that network destination 144, with address 115.115.115.115, was compromised from Jan. 1, 2010 until Jan. 5, 2010. Anti-malware may determine from network log 204 that e-mail application 116 accessed the network destination 144 on Jan. 4, 2010, as well as browser application 118. Anti-malware may then determine from file/application log whether the browser application 118 or e-mail application were vulnerable to the exploitation, through evaluating, for example, the version 212 of the application. Anti-malware application 102 may determine, based on information such as historical forensics rules 130, whether the specific version of the application was vulnerable to the compromised network destination 144 that it accessed. For example, browser application 118 might have been patched on Jan. 3, 2010 with version 2.4, protecting browser application 118 from the security hole when it accessed the network destination 144 on Jan. 4, 2010. E-mail application 118 might not have ever been vulnerable to the security hole. Conversely, e-mail application 118 might have been vulnerable to the exploitation under its installed version, 8.3, when it accessed the network destination Jan. 4, 2010. Anti-malware application 102 may make such determinations based on metadata 150 and upon logical associations of the metadata 150 and malware as described in historical forensics rules 130. Anti-malware application 102 may alert users based upon its determinations. For example, evidence that e-mail application 116 accessed a vulnerable website may be presented to the user, along with suggestions to patch e-mail application to a newer version fixing the problem. Additional anti-malware scanning may be undertaken by anti-malware application 102. Even though browser application 118 might have been correctly patched before accessing the compromised network destination 144, anti-malware application 102 may alert the user. This may provide assurances that, for example, a highly publicized security problem with the network destination has not affected electronic device 104, even though the network destination 144 was accessed.

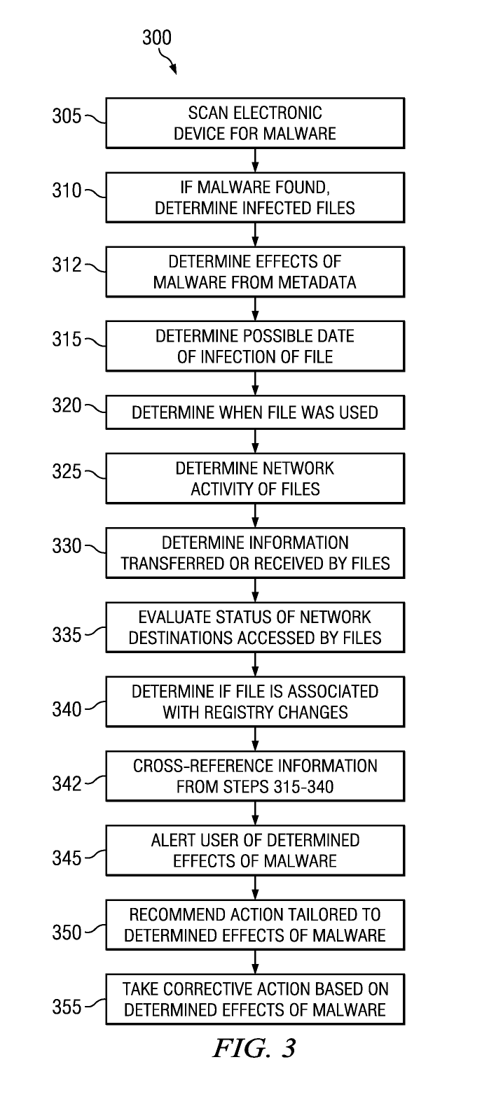

FIG. 3 shows an example embodiment of a method 300 for utilizing historical information to detect the effects of malware, and alert a user. In step 305, an electronic device may be scanned for malware. Such scanning may utilize any suitable detection information. If malware is found, then analysis may be conducted to determine additional information about the malware infection, and its effects upon electronic device or users of electronic device. In step 310, the infected files, applications, modules, or other entities of the electronic device may be identified. Such infected portions of the electronic device may be determined as hosting the malware, or may be related to the host of the malware.

In step 312, the effects of the infected malware may be determined by examination of historical information, such as metadata. The effects may be determined by analyzing the relationship between metadata and the infected portions of electronic device. The effects may be determined by utilizing any suitable logical connection between metadata and infected portions of electronic device. In one embodiment, the effects may be determined by one or more of steps 315-342.

In step 315, a possible date of infection may be determined for the infected file. For example, if the file was modified on a particular day, after which a scan of electronic device determined that the file was infected, but previous scans had not found such an infection, the modification day may be determined as a possible date of infection. Possible dates of infection may be used to determine other effects of malware infection.

In step 320, whether and when the file has been used, executed, or accessed may be determined. In one embodiment, such determinations may be made for possible use, execution, or access after possible infection dates. Whether and when the file has been used, executed, or accessed may be used to determine other effects of malware infection. It may be determined whether the file was modified, compiled, or changed in any way. A hash of the file may be evaluated. The contents of the file, or metadata of the file, may be compared against known values, such as previous values.

In step 325, network activity of infected files, or of files associated with infected files, may be determined. Such network activity may be determined by accessing network activity records. The network activity may be determined by examining information for a given file after possible dates of infection. The content of network activity may be examined. In step 330, any information that has been received or sent by infected files, or by files associated with infected files, may be examined. Such information may be examined, for example, for compromised sensitive information, or for malware. In step 335, the identified network destinations in communication with the electronic device as part of the network activity may be examined and, for example, reviewed for any association with malware. The identified network destinations may be reviewed to determine if they comprise sensitive information. The information from steps 325-225 may be used to determine other effects of malware infection.

In step 340, whether the file is associated with registry changes may be determined. Such information may be determined by accessing records of changes made to the registry. Such information may show that one or more applications have been affected by the infected file. Any changed registry keys and values may be determined. Such information may be used to determine other effects of malware infection.

In step 342, information determined from various techniques of determining the effects of malware from metadata may be cross-referenced with each other, and certain steps repeated. For example, if an infected file changed a registry setting of another application, the network activity of the other application may be examined to determine whether or not data was compromised by the other application. Other examples may be found described above.

After effects of malware are determined from examination of historical information, various action may be taken in steps 345-355 based upon the determined effects. In step 345, a user may be alerted as to the determined effects. Such alerts may indicate the risks encountered, risks avoided, information compromised, or any other suitable information determined from the steps above. In step 350, actions to counteract the malware infection may be recommended, tailored to the determined effects of malware. Such action may include removing malware, taking steps to minimize the harm done by compromised data, or any suitable action. In step 355, such actions may be taken, based on determined effects of malware.

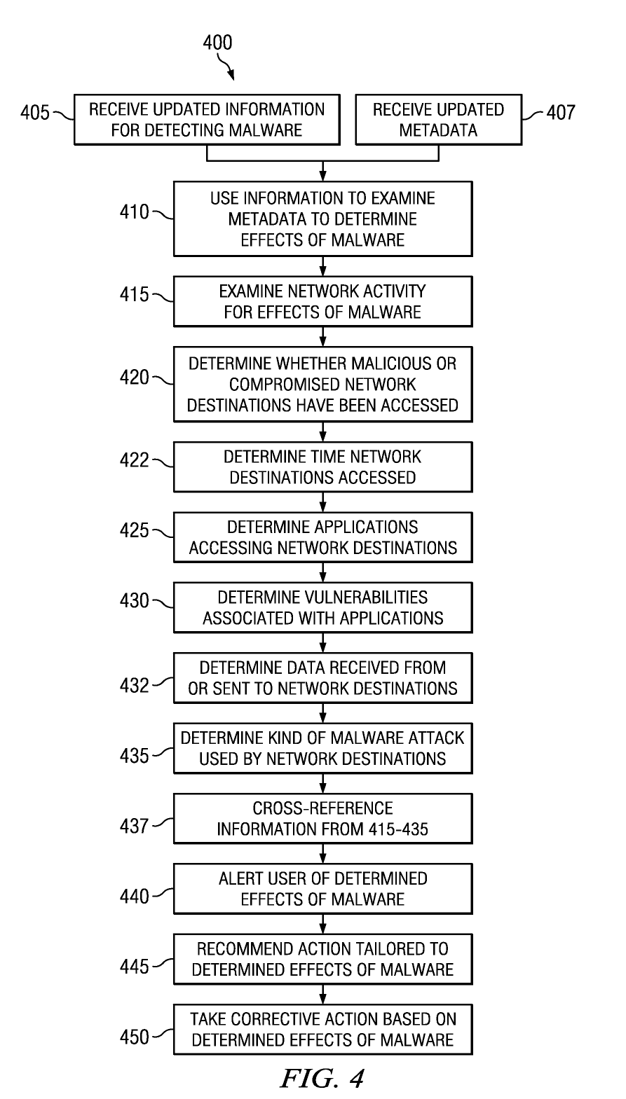

FIG. 4 shows another example embodiment of a method 400 for utilizing historical information to detect the effects of malware, and alert a user. In step 405, information for detecting malware may be received. Such information for detecting malware may include any suitable information for inspecting historical information for evidence of a malware infection. For example, such detection information may include reputation information describing the association of a network destination with malware. In step 407, historical information, such as metadata, associated with a electronic device may be generated or received. In one embodiment, steps 405 and 407 may be occur in parallel. In another embodiment, one of steps 405 or 407 may be omitted.

In step 410, the detection information may be used to examine historical information, such as metadata, to determine any effects or indications of malware. Any suitable technique may be used to examine historical information. In one embodiment, step 410 may be conducted using detection information that was received in step 405. In such an embodiment, the newly received detection information may be applied to historical information that had previously been examined using previous detection information. In another embodiment, step 410 may be conducted using detection information upon newly generated or received historical information from step 407. In such an embodiment, the detection information may be applied to the newly generated or received historical information. In such an embodiment, such examinations may take places as soon as historical information is generated. In yet another embodiment, step 410 may be conducted by using a combination of detection information from step 405 and updated historical information from step 407.

Step 410 may be implemented by one or more of steps 415-437. Determinations made in any of steps 415-437, or in any suitable technique for fully or partially implementing step 410, may be used in combination with other techniques to determine the presence or effects of malware. In one embodiment, one or more techniques used while conducting step 410 may be repeated in light of the results of another technique used while conducting step 410. In step 415, evidence of network activity may be examined to determine any effects of malware. Such evidence may be in the form of a network activity log. In step 420, if may be determine whether malicious or compromised network destinations have been accessed. A malicious network destination may be, for example, a network destination associated with a phishing attack. A compromised network destination may be, for example, a network destination with a security hole making it vulnerable to malware attacks. In step 422, the date or time of the access of such network destinations may be determined.

In step 425, it may be determined what applications, executables, scripts, libraries, or other files accessed malicious or compromised network destinations. In step 430, it may be determined whether applications, libraries, executables, or other digital entities of the electronic device have any vulnerabilities associated with risks of malware of exploitation. Such determinations may be cross-referenced with applications that have accessed network destinations, or that have accessed particular malicious network destinations. Such determinations may be based in part upon versions or patches of the applications.

In step 430, it may be determined what information was sent to or from the electronic device to or from a network destination. Such information may be identified by conducting a hash or other signature of the information, size, file name, or any other suitable technique. The contents of the information may be determined. Such contents may be scanned for sensitive, private, or other special information that may have been compromised. Such contents may be scanned for indications of malware. In step 435, it may be determined what kind of malware attack was used by a particular network destination. Such a determination may come from, for example, reputation information, or analysis of downloaded content.

In step 437, information determined from various techniques of determining the effects of malware from metadata may be cross-referenced with each other, and certain steps repeated. For example, if an application accessed a website, the website hacked to host malware that used browser exploitations to inject a Trojan, wherein the browser was vulnerable to the exploitation, various determinations from steps 420, 422, 425, 430, and 435 may be used to determine the complete malware scenario encountered by the electronic device.

After effects of malware are determined from examination of historical information, various action may be taken in steps 415-437 based upon the determined effects. In step 440, a user may be alerted as to the determined effects. Such alerts may indicate the risks encountered, risks avoided, information compromised, or any other suitable information determined from the steps above. In step 445, actions to counteract the malware infection may be recommended, tailored to the determined effects of malware. Such action may include removing malware, taking steps to minimize the harm done by compromised data, or any suitable action. In step 450, such actions may be taken, based on determined effects of malware.

Methods 300 and 400 may be implemented using the system of FIGS. 1-2, or any other system operable to implement methods 300 and 400. As such, the preferred initialization point for methods 300 and 400 and the order of the steps comprising methods 300 and 400 may depend on the implementation chosen. In some embodiments, some steps may be optionally omitted, repeated, or combined. In some embodiments, some steps of method 300 may be accomplished in method 400, and vice-versa. In some embodiments, portions or all of methods 300 and 400 may be combined. In certain embodiments, methods 300 and 400 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other tangible, non-transitory media; and/or any combination of the foregoing.

Although the present invention has been described with several embodiments, various changes and modifications may be suggested to one skilled in the art. It is intended that the present invention encompass such changes and modifications as fall within the scope of the appended claims.

What is claimed is:

1. A method for malware protection, comprising:
receiving detection information for detecting malware on an electronic device;
accessing historical information of an electronic device;
comparing the detection information to the historical information; and
based on the comparison of the detection information with the historical information, alerting a user of the electronic device of risks of malware evidenced by the historical information;
wherein comparing detection information to the historical information comprises:
determining that information from a first category of historical information is associated with a source of malware;
cross-referencing information from a second category of historical information to the information from the first category; and
associating the information from the second category with the malware.

2. The method of claim 1, further comprising:
scanning the electronic device for malware; and
determining that the electronic device may have been infected with malware;
wherein the detection information is associated with the malware which may have infected the electronic device.

3. The method of claim 1, further comprising:
determining that the electronic device may have been infected with malware, wherein such determination is based upon the comparison of the detection information with the historical information.

4. The method of claim 1, further comprising:
including the information from the second category with the alerts sent to the user.

5. The method of claim 1, wherein one of the categories of historical information comprises network activity.

6. The method of claim 1, wherein the second category of historical information comprises data sent to or from a network destination.

7. The method of claim 1, wherein one of the categories of historical information comprises changes to an operating system.

8. The method of claim 1, wherein the second category of historical information comprises a vulnerability status of an application possibly exposed to malware.

9. The method of claim 1, wherein one of the categories of historical information comprises an execution history of an application associated with malware.

10. The method of claim 1, wherein comparing detection information to historical information comprises determining a possible date of malware exposure.

11. The method of claim 1, wherein the first and second categories of historical information comprise network activity.

12. The method of claim 1, wherein:
the first category of historical information comprises network activity; and
the second category of historical information comprises an execution history of an application associated with malware.

13. The method of claim 1, wherein:
the first category of historical information comprises network activity; and
the second category of historical information comprises a vulnerability status of an application possibly exposed to malware.

14. The method of claim 1, wherein:
the first category of historical information comprises network activity; and
the second category of historical information comprises data sent to or from a network destination.

15. The method of claim 1, wherein:
the first category of historical information comprises results of behavioral analysis; and
the second category of historical information comprises network activity.

16. An article of manufacture, comprising:
a computer readable medium; and
computer-executable instructions carried on the computer readable medium, the instructions readable by a processor, the instructions, when read and executed, for causing the processor to:
receive detection information for detecting malware on an electronic device;
access historical information of an electronic device;
compare detection information to the historical information; and
based on the comparison of the detection information with the historical information, alert a user of the electronic device of risks of malware, the risks evidenced by the historical information.
wherein causing the processor to compare detection information to the historical information comprises causing the processor to:
determine that information from a first category of historical information is associated with a source of malware;
cross-reference information from a second category of historical information to the information from the first category; and
associate the information from the second category with the malware.

17. The article of claim 16, wherein the processor is further configured to:
scan the electronic device for malware; and
determine that the electronic device may have been infected with malware;
wherein the detection information is associated with the malware which may have infected the electronic device.

18. The article of claim 16, wherein the processor is further configured to:
determine that the electronic device may have been infected with malware, wherein such determination is based upon the comparison of the detection information with the historical information.

19. The article of claim 16, wherein configuring the processor to compare detection information to historical information comprises further configuring the processor to include the information from the second category with the alerts sent to the user.

20. The article of claim 16, wherein one of the categories of historical information comprises network activity.

21. The article of claim 16, wherein the second category of historical information comprises data sent to or from a network destination.

22. The article of claim 16, wherein one of the categories of historical information comprises changes to an operating system.

23. The article of claim 16, wherein the second category of historical information comprises a vulnerability status of an application exposed to malware.

24. The article of claim 16, wherein the second category of historical information comprises an execution history of an application associated with malware.

25. The article of claim 16, wherein configuring the processor to compare detection information to historical information comprises configuring the processor to determine a possible date of malware exposure.

26. The article of claim 16, wherein the first and second categories of historical information comprise network activity.

27. The article of claim 16, wherein:
the first category of historical information comprises network activity; and
the second category of historical information comprises an execution history of an application associated with malware.

28. The article of claim 16, wherein:
the first category of historical information comprises network activity; and
the second category of historical information comprises a vulnerability status of an application possibly exposed to malware.

29. The article of claim 16, wherein:
the first category of historical information comprises network activity; and
the second category of historical information comprises data sent to or from a network destination.

30. The article of claim 16, wherein:
the first category of historical information comprises results of behavioral analysis; and
the second category of historical information comprises network activity.
